(19) United States
(12) Patent Application Publication
(10) Pub. No.: US 2024/0392405 A1
(43) Pub. Date: Nov. 28, 2024

(54) COLD ROLLED AND HEAT TREATED STEEL SHEET AND A METHOD OF MANUFACTURING THEREOF

(71) Applicant: ArcelorMittal, Luxembourg (LU)

(72) Inventors: Tom WATERSCHOOT, Lokeren (BE); Arunim RAY, Zwijnaarde (BE); Rénald DAVID, Grande-Synthe (FR)

(21) Appl. No.: 18/693,424

(22) PCT Filed: Sep. 29, 2021
(86) PCT No.: PCT/IB2021/058916

§ 371 Date: Mar. 19, 2024

(51) Int. Cl. C21D 9/46; C21D 1/18; C21D 6/00; C21D 8/02; C22C 38/00; C22C 38/02; C22C 38/04; C22C 38/06; C22C 38/12

(52) U.S. Cl. CPC C21D 9/46; C21D 1/18; C21D 6/005; C21D 6/008; C21D 8/0205; C21D 8/0226; C21D 8/0236; C21D 8/0263; C21D 8/0278; C22C 38/001; C22C 38/002; C22C 38/02; C22C 38/04; C22C 38/06; C22C 38/12; C21D 2211/005

(57) ABSTRACT

A cold rolled and heat treated steel sheet having a composition including of the following elements, 0.05%≤Carbon≤0.12%, 1.0%≤Manganese≤2%, 0.01%≤Silicon≤0.5%, 0.01%≤Aluminum≤0.1%, 0.01%≤Niobium≤0.1%, 0%≤Phosphorus≤0.09%, 0%≤Sulfur≤0.09%, 0%≤Nitrogen≤0.09%, 0.1%≤Chromium≤0.5%, 0%≤Nickel≤3%, 0%≤Titanium≤0.1%, 0%≤Calcium≤0.005%, 0%≤Copper≤2%, 0%≤Molybdenum≤0.5%, 0%≤Vanadium≤0.1%, 0%≤Boron≤0.003%, 0%≤Cerium≤0.1%, 0%≤Magnesium≤0.010%, 0%≤Zirconium≤0.010% the remainder composition being composed of iron and unavoidable impurities caused by processing, the microstructure of the steel sheet including in area fraction, 50 to 90% Recrystallized ferrite, 10 to 50% non-recrystallized ferrite, 0% to 15% Cementite and 0.5% to 2% Carbides of Niobium, wherein the cumulated amount of Recrystallized ferrite and Non-recrystallized ferrite is at least 85%.

The present invention relates to cold rolled and heat treated steel sheets suitable for use as steel sheet for automobiles.

### BACKGROUND

Structural steels are required to satisfy two inconsistent necessities, e.g. ease of forming and strength but in recent years a third requirement of improvement in terms of CO2 consumption impact is also bestowed upon these structural steels, that are intended to be used for building solar frames, racking, silos, roofing, cladding and other similar purposes, in view of global environment concerns. Thus, now structural steel must be made of material having high strength in order that to fit in the criteria of durability and longevity.

Therefore, intense Research and development endeavors are put in to reduce the amount of material utilized in automobiles by increasing the strength of material. Conversely, an increase in strength of steel sheets decreases formability, and thus development of materials having both high strength and high formability is necessitated.

### SUMMARY OF THE INVENTION

Earlier research and developments in the field of high strength and high formability steel sheets have resulted in several methods for producing high strength and high formability steel sheets, some of which are enumerated herein for conclusive appreciation of the present invention:

U.S. Pat. No. 10,920,293 is a steel sheet of a composition comprising, in mass %, C: 0.07 to 0.19%, Si: 0.09% or less, Mn: 0.50 to 1.60%, P: 0.05% or less, S: 0.01% or less, Al: 0.01 to 0.10%, N: 0.010% or less, and the balance Fe and unavoidable impurities, and of a micro structure that contains ferrite as a primary phase, and 2 to 12% of perlite, and 3% or less of martensite by volume, and in which the remainder is a low-temperature occurring phase, the ferrite having an average crystal grain diameter of 25 μm or less, the perlite having an average crystal grain diameter of 5 μm or less, the martensite having an average crystal grain diameter of 1.5 μm or less, and the perlite having a mean free path of 5.5 μm or more. However the steel of U.S. Pat. No. 10,920,293 is not able to achieve the tensile strength of 600 MPa or more.

It is an object of the present invention is solve these problems by making available cold-rolled steel sheets that simultaneously have:
A TS/YS ratio greater than or equal to 1.10.
an ultimate tensile strength greater than or equal to 600 MPa,
an total elongation greater than or equal to 14% and preferably an total elongation greater than or equal to 15%.

Preferably, such steel has a yield strength greater than or equal to 550 MPa and preferably above 580 Mpa.

Preferably, such steel can also have a good suitability for forming, for rolling with good weldability, bendability and coatability.

Preferably, such steel can also have a hole expansion ratio of more than 40%.

Another object of the present invention is also to make available a method for the manufacturing of these sheets that is compatible with conventional industrial applications while being robust towards manufacturing parameters shifts.

### DETAILED DESCRIPTION

The cold rolled and heat treated steel sheet of the present invention is be coated with zinc or zinc alloys, or with aluminium or aluminium alloys to improve its corrosion resistance.

Carbon is present in the steel from 0.05% to 0.12%. Carbon is an element necessary for increasing the strength of the steel sheet by interstitial strengthening as well as via forming microalloyed precipitates. If C is lower than 0.05 wt %, it is difficult to achieve the required yield strength 550 MPa or more and total elongation of more than 14% simultaneously. Whenever the carbon content is higher than 0.12% it degrades coatability and exhibits poor adhesion at the steel-coating interface. Carbon content higher than 0.12% decreases the Ac1 temperature due to which second phases like pearlite, bainite, martensite can form at relatively low soaking temperatures which decreases hole-expansion ratio as well as increases work-hardening during bending which is not recommended. The preferred range for carbon for the steel of the present invention is therefore 0.05% to 0.11% and more preferably 0.07% to 0.095%.

Manganese content of the steel of the present invention is from 1.0% to 2%; The purpose of adding Manganese is essentially to impart strength to the steel by solid solution strengthening. If Mn is lower than 1%, it is difficult to achieve the required yield strength 550 MPa or more and the total elongation higher than 14% simultaneously. When Mn content is added more than 2% the transformation from austenite to pearlite is suppressed and martensite and/or, bainite is formed, resulting into poor weldability in terms of increased hardness in the heat-affected zone (HAZ) and surface cracking becomes likely to occur during welding. A preferable content for the present invention may be kept from 1.1% to 1.9%, further more preferably 1.2% to 1.8% to ensure good bendability of the steel of the present invention.

Silicon content of the steel of the present invention is from 0.01% to 0.5%. Silicon adds strength to ferrite through solid solution strengthening because of this effect the hole expansion rate tends to increase and also ensures good ductility. However, when contained in an amount more than 0.5%, silicon concentrates at the steel sheet surface in the form of an oxide during annealing, and the coatability deteriorates and causes embrittlement. An excess silicon content of more than 0.5% also impairs toughness at high temperature, and often causes surface cracking at the time of welding. For this reason, the Silicon content is restricted to 0.5% or less. The Silicon content is preferably from 0.01% to 0.4% and more preferably from 0.01% to 0.3%.

Aluminum is an essential element and is present in the steel of the present invention from 0.01% to 0.1%. Aluminum promotes ferrite formation and increases the Ms temperature which allows the present invention to have Ferrite in adequate amount as required by the steel of the present invention to impart steel of the present invention with ductility as well as strength. However, when the presence of Aluminum is more than 0.1% it increases the Ac3 temperature which makes the annealing and hot rolling finishing temperature in complete Austenitic region economically unreasonable. The Aluminum content is preferably limited from 0.01% to 0.09% and more preferably 0.01% to 0.05%.

Niobium is an essential element for the Steel of the present invention from 0.01% to 0.1% and suitable for forming carbides and Carbonitrides to impart strength of the steel of the present invention by precipitation hardening. Niobium will also impact the size of microstructural components through its precipitation as carbides and by retarding the recrystallization during heating process. Thus, finer microstructure formed in the final product as a consequence the steel of the present invention is able to reach the targeted strength. However, Niobium content above 0.1% is not economically interesting as well as forms coarser precipitates which are detrimental for the properties like hole expansion ratio, elongation of the steel and also when the content of niobium is 0.1% or more niobium is also detrimental for steel hot ductility resulting in difficulties during steel casting and rolling. The preferred limit for niobium content is from 0.01% to 0.09% and more preferably from 0.01% to 0.05%

Phosphorus is not an essential element but may be contained as an impurity in steel and from the point of view of the present invention the phosphorus content is preferably as low as possible, and below 0.09%. Phosphorus reduces the spot weldability and the hot ductility, particularly due to its tendency to segregate at the grain boundaries or co-segregate with manganese. For these reasons, its content is limited to less than 0.09%, preferably less than 0.03% and more preferably less than 0.014%.

Sulfur is not an essential element but may be contained as an impurity in steel and from the point of view of the present invention the Sulfur content is preferably as low as possible, but is 0.09% or less from the viewpoint of manufacturing cost. Further if higher Sulfur is present in the steel it combines to form Sulfides especially with Manganese and reduces its beneficial impact on the steel of present invention.

Nitrogen is limited to 0.09% to avoid ageing of material and to minimize the precipitation of nitrides during solidification which are detrimental for mechanical properties of the Steel.

Chromium is an optional element for the present invention. Chromium content may be present in the steel of the present invention from 0.1% to 0.5%. Chromium provides strength and hardening to the steel but when used above 0.5% it impairs surface finish of steel. The preferred limit for Chromium for the present invention is from 0.1% to 0.4% and more preferably 0.2% to 0.4%.

Nickel may be added as an optional element in an amount up to 3% to increase the strength of the steel and to improve its toughness. A minimum of 0.01% is preferred to produce such effects. However, when its content is above 3%, Nickel causes ductility deterioration.

Titanium is an optional element and may be added to the Steel of the present invention up to 0.1%. As Niobium, it is involved in carbo-nitrides formation so plays a role in hardening of the Steel of the present invention. In addition, Titanium also forms Titanium-nitrides which appear during solidification of the cast product. The amount of Titanium is so limited to 0.1% to avoid formation of coarse Titanium-nitrides detrimental for formability. In case the Titanium content is below 0.001% it does not impart any effect on the steel of the present invention.

Calcium content in the steel of the present invention is up to 0.005%. Calcium is added to steel of the present invention as an optional element especially during the inclusion treatment with a preferred minimum amount of 0.0001%. Calcium contributes towards the refining of Steel by arresting the detrimental Sulfur content in globular form, thereby, retarding the harmful effects of Sulfur.

Copper may be added as an optional element in an amount up to 2% to increase the strength of the steel and to improve its corrosion resistance. A minimum of 0.01% of Copper is preferred to get such effect. However, when its content is above 2%, it can degrade the surface aspects.

Molybdenum is an optional element that constitutes up to 0.5% of the Steel of the present invention; Molybdenum plays an effective role in determining hardenability and hardness, delays the appearance of Bainite and avoids carbides precipitation in Bainite. However, the addition of Molybdenum excessively increases the cost of the addition of alloy elements, so that for economic reasons its content is limited to 0.5%.

Vanadium is effective in enhancing the strength of the steel by forming carbides or carbo-nitrides and the upper limit is 0.1% due to the economic reasons. Other elements such as Cerium, Boron, Magnesium or Zirconium can be added individually or in combination in the following proportions by weight: Cerium≤0.1%, Boron≤0.003%, Magnesium≤0.010% and Zirconium≤0.010%. Up to the maximum content levels indicated, these elements make it possible to refine the grain during solidification. The remainder of the composition of the Steel consists of iron and inevitable impurities resulting from processing.

The microstructure of the Steel sheet will now be described.

Recrystallized ferrite constitutes from 50% to 90% of microstructure by area fraction of the steel of the present invention and it is advantageous to have an average grain size of 3.6 microns or less and preferably the average grain size is from 2 microns to 3.6 microns. This recrystallized ferrite imparts the steel of the present invention with a total elongation of at least 14%. However, when the recrystallized ferrite content is present above 90% in the matrix of the steel of the present invention, it is not possible to achieve the yield strength of 550 MPa. Recrystallized ferrite grains are defined as dislocation-free equiaxed grains that nucleate and grow during heating and soaking below the Ac1 temperature during annealing after cold-rolling. The preferred limit for the presence of recrystallized ferrite in the matrix for the present invention is therefore from 54% to 85% by area fraction and more preferably from 54% to 80%

Non-recrystallized ferrite constitutes from 10% to 50% of microstructure by area fraction of the steel of present invention. Non-recrystallized ferrite grains are defined as dislocation containing elongated ferrite grains that formed during cold-rolling and did not recrystallize during heating and soaking below the Ac1 temperature during annealing after cold-rolling. Non-recrystallized ferrite contributes to the high strength in the steel of the present invention and to ensure yield strength of 550 MPa or, more, it is necessary to have at least 10% non-recrystallized ferrite. But when the non-recrystallized ferrite content is present above 50% in the matrix of the steel of the present invention, it is not possible to achieve the total elongation of at least 14%. The preferred limit for presence of the non-recrystallized ferrite for the present invention is therefore from 15% to 50% by area fraction and more preferably from 20% to 48%

The cumulative presence of Non-recrystallized ferrite and recrystallized ferrite can be at least 85% and preferably at least 90% and more preferably at least 98 or 99.5%. Non-Etching with Dino's etchant (140 ml of distilled water, 100 ml of H2O2, 4 g of oxalic acid, 2 ml of H2SO4 and 1.5 ml of HF) is used to differentiate between recrystallized and non-recrystallized ferrite microconstituents from an optical micrograph. The area fraction for each constituents is measured as per the ASTM E562.

Niobium Carbides are present in the steel of the present invention. It is advantageous according to the present invention that the size of the Niobium carbide precipitates is from 2 nm to 200 nm and more preferably 2 nm to 20 nm. The niobium carbides of the present invention include both intragranular niobium carbides (i.e. precipitate inside the ferrite grains so called intragranular niobium carbides) and intergranular niobium carbides (i.e. precipitate on the ferrite grain boundaries so called intergranular niobium carbides). The homogenous and coherent precipitation of the niobium carbide increases the strength of the steel. The limit for the presence of the niobium carbide is from 0.5% to 2% by area fraction and more preferably from 0.5% to 1.5% by areas fraction.

Cementite can be optional present in the steel of the present invention from 0% to 15%. Cementite imparts the present invention with strength, however when the presence of Cementite is above 15% the total elongation is not achieved.

In addition to the above-mentioned microstructure, the microstructure of the cold rolled and heat treated steel sheet is free from microstructural components, such as pearlite, bainite and martensite without impairing the mechanical properties of the steel sheets.

A steel sheet according to the invention can be produced by any suitable method. A preferred method consists in providing a semi-finished casting of steel with a chemical composition according to the invention. The casting can be done either into ingots or continuously in form of thin slabs or thin strips, i.e. with a thickness ranging from approximately 220 mm for slabs up to several tens of millimeters for thin strip.

For example, a slab having the above-described chemical composition is manufactured by continuous casting wherein the slab optionally underwent the direct soft reduction during the continuous casting process to avoid central segregation and to ensure a ratio of local Carbon to nominal Carbon kept below 1.10. The slab provided by continuous casting process can be used directly at a high temperature after the continuous casting or may be first cooled to room temperature and then reheated for hot rolling.

The temperature of the slab, which is subjected to hot rolling, is at least 1000° C. and must be below 1280° C. In case the temperature of the slab is lower than 1000° C. the dissolution of Niobium does not takes places completely and consequently Niobium will not form adequate carbides during annealing and additionally there may be excessive load is imposed on a rolling mill if temperature if less than 1000° C. and, further, the temperature of the steel may decrease to a Ferrite transformation temperature during finishing rolling, whereby the steel will be rolled in a state in which transformed Ferrite contained in the structure. Therefore, the temperature of the slab is preferably sufficiently high so that hot rolling can be completed in the temperature range of Ac3 to Ac3+100° C. and final rolling temperature must remains above Ac3. Reheating at temperatures above 1280° C. must be avoided because they are industrially expensive.

A final rolling temperature range from Ac3 to Ac3+100° C. is necessary to have a structure that is favorable to recrystallization and rolling. It is preferred that the final rolling pass to be performed at a temperature greater than 850° C., because below this temperature the steel sheet exhibits a significant drop in rollability. The hot rolled steel obtained in this manner is then cooled at a cooling rate above 20° C./s to the coiling temperature which must be from 450° C. to 650° C. The objective of keeping the coiling temperature from 450° C. to 650° C. is to keep the microalloying elements such as Niobium in solid solution in the hot band to maximize precipitation during annealing after cold rolling. Preferably, the cooling rate will be less than or equal to 200° C./s.

The hot rolled steel is then coiled at a coiling temperature from 450° C. to 650° C. to avoid ovalization and preferably from 450° C. to 625° C. to avoid scale formation. A more preferred range for such coiling temperature is from 460° C. to 625° C. The coiled hot rolled steel is cooled down to room temperature before subjecting it to optional hot band annealing.

The hot rolled steel may be subjected to an optional scale removal step to remove the scale formed during the hot rolling before optional hot band annealing. The hot rolled sheet may then subjected to an optional Hot Band Annealing at, for example, temperatures from 400° C. to 750° C. for at least 12 hours and not more than 96 hours, the temperature remaining below 750° C. to avoid transforming partially the hot-rolled microstructure and, therefore, losing the microstructure homogeneity. Thereafter, an optional scale removal step of this hot rolled steel may performed through, for example, pickling of such sheet. This hot rolled steel is subjected to cold rolling to obtain a cold rolled steel sheet with a thickness reduction from 35 to 90%. The cold rolled steel sheet obtained from cold rolling process is then subjected to annealing to impart the steel of present invention with microstructure and mechanical properties.

The annealing of the cold rolled steel sheet is performed in two steps heating wherein the first step starts from heating the steel sheet from room temperature to a temperature T1 which is from 580° C. to 650° C., with a heating rate HR1 of at least 20° C./s. It is advantageous to keep T1 temperature below the recrystallisation initiation temperature which is calculated by differential scanning calorimetry experiments as per paper published as “Differential scanning calorimetry study of constrained groove pressed low carbon steel: recovery, recrystallisation and ferrite to austenite phase transformation” on Pages 765-773 in Taylor and Francis on 6 Dec. 2013. Thereafter the second step starts from heating further the steel sheet from T1 to a soaking temperature T2 from 700° C. to 760° C., with a heating rate HR2 of at least 2° C./s, HR2 being lower than HR1, then perform annealing at T2 during 10 to 500 seconds. In a preferred embodiment, the heating rate for the second step the heating rate is less than 10° C./s and more preferably less than 8° C./s. The preferred temperature T2 for soaking is from 700° C. to Ac1-50° C.

Then the cold rolled steel is cooled from T2 to temperature range T3 from 400° C. to 500° C., preferably from 420° C. to 490° C., at an average cooling rate of at least 10° C./s and preferably at least 15° C./s, wherein the cooling step may include an optional slow cooling sub-step within the T3 temperature range with a cooling rate of 2° C./s or less and preferably of 1° C./s or less. The cold rolled steel sheet is held within the temperature range T3 during 10 to 500 seconds.

Then the cold rolled steel sheet can then be brought to the temperature of the coating bath from 420° C. to 480° C., depending on the nature of the coating, to facilitate hot dip coating of the cold rolled steel sheet.

The cold rolled steel sheet can also be coated by any of the known industrial processes such as Electro-galvanization, JVD, PVD, etc., which may not require bringing it to the above mentioned temperature range before coating.

Then an optional post batch annealing may be done at a temperature from 150° C. to 300° C. during 30 minutes to 120 hours.

Thereafter, skin pass rolling can be performed on the cold rolled steel sheet with a minimum skin pass reduction of 1.3% or more and preferably more than 1.4% reduction or more.

### EXAMPLES

The following tests, examples, figurative exemplification and tables which are presented herein are non-restricting in nature and must be considered for purposes of illustration only, and will display the advantageous features of the present invention.

Steel sheets made of steels with different compositions are gathered in Table 1, where the steel sheets are produced according to process parameters as stipulated in Table 2, respectively. Thereafter Table 3 gathers the microstructures of the steel sheets obtained during the trials and table 4 gathers the result of evaluations of obtained properties.

TABLE 1

| Trials | C | Mn | Si | Al | Nb | P | S | N | Ti |
|---|---|---|---|---|---|---|---|---|---|
| I1 | 0.08 | 1.45 | 0.03 | 0.025 | 0.031 | 0.012 | 0.002 | 0.005 | 0 |
| I2 | 0.08 | 1.45 | 0.03 | 0.025 | 0.025 | 0.012 | 0.002 | 0.005 | 0 |
| I3 | 0.08 | 1.45 | 0.03 | 0.025 | 0.025 | 0.012 | 0.002 | 0.005 | 0 |
| I4 | 0.08 | 1.45 | 0.03 | 0.025 | 0.031 | 0.012 | 0.002 | 0.005 | 0 |
| R1 | 0.08 | 1.45 | 0.03 | 0.025 | 0.032 | 0.012 | 0.002 | 0.005 | 0 |
| R2 | 0.07 | 0.9 | 0.03 | 0.035 | 0.06 | 0.014 | 0.007 | 0.005 | 0.042 |
| R3 | 0.07 | 0.9 | 0.03 | 0.035 | 0.05 | 0.014 | 0.007 | 0.005 | 0.042 |

underlined values: not according to the invention.

### Table 2

Table 2 gathers the annealing process parameters implemented on steels of Table 1. The Steel compositions 11 to 13 and R1 to R5 serve for the manufacture of sheets according to the invention. Table 2 also shows tabulation of Ac1 and Ac3. These Ac1 and Ac3 are defined for the inventive steels and reference steels by dilatometry study conducted according to ASTM A1033-04 standard.

Following processing parameters are same for all the steels of Table 1. All steels of table 1 are heated to a temperature of 1200° C. before hot rolling. and they were finally brought at a temperature of 460° C. before zinc hot dip coating.

The table 2 is as follows:

TABLE 2

| | Hot Rolling | | | | | | | | | | | | | | |
|---|---|---|---|---|---|---|---|---|---|---|---|---|---|---|---|
| | | Cooling | | | | | | | | | | | | | |
| | | rate after | | | Annealing | | | | | | | | | | |
| | | Hot | | Cold | | | | | Soaking | cooling rate | Holding | | Skin | | |
| | Finish | Rolling | Coiling | Rolling | HR1 | T1 | HR2 | | time | after annealing | time at T3 | T3 | pass | Ac3 | Ac1 |
| Trials | T(° C.) | (° C./s) | T(° C.) | (%) | (° C./s) | (° C.) | (° C./s) | T2 | (s) | (° C./s) | (s) | (° C.) | (%) | (° C.) | (° C.) |
| I1 | 870 | 30 | 470 | 70 | 34 | 605 | 5 | 730 | 25 | 28 | 21 | 460 | 1.5 | 860 | 800 |
| I2 | 870 | 30 | 495 | 70 | 34 | 600 | 5 | 717 | 24 | 27 | 20 | 460 | 1.3 | 860 | 800 |
| I3 | 870 | 30 | 545 | 67 | 70 | 625 | 7 | 720 | 13 | 52 | 11 | 460 | 1.3 | 860 | 800 |
| I4 | 870 | 30 | 530 | 65 | 25 | 625 | 3 | 725 | 35 | 19 | 30 | 460 | 1.5 | 860 | 800 |
| R1 | 870 | 30 | 470 | 70 | 58 | 710 | 5 | 780 | 18 | 48 | 15 | 460 | 1.0 | 860 | 800 |
| R2 | 870 | 30 | 530 | 70 | 48 | 680 | 5 | 775 | 21 | 39 | 17 | 460 | 1.0 | 880 | 820 |
| R3 | 870 | 30 | 530 | 70 | 45 | 650 | 5 | 750 | 21 | 36 | 18 | 460 | 1.0 | 880 | 820 |

I = according to the invention; R = reference; underlined values: not according to the invention.

### Table 3

Table 3 exemplifies the results of the tests conducted in accordance with the standards on different microscopes such as Scanning Electron Microscope for determining the microstructures of both the inventive and reference steels.

The results are stipulated herein:

| | | | | | | Non- |
|---|---|---|---|---|---|---|
| | | | | | | Recrystallized |
| | | Recrystallized | Non- | | | Ferrite + |
| | Recrystallized | Ferrite -grain | Recrystallized | Niobium | | Recrystallized |
| | Ferrite | size | Ferrite | Carbide | Cementite | Ferrite |
| Trials | (area %) | (microns) | (area %) | (area %) | (area %) | (area %) |
| I1 | 69 | 2.3 | 30 | 1 | 0 | 99 |
| I2 | 59 | 2.8 | 40 | 1 | 0 | 99 |
| I3 | 59 | 2.3 | 40 | 1 | 0 | 99 |
| I4 | 55 | 3.1 | 44 | 1 | 0 | 99 |
| R1 | 100 | 3.9 | 0 | 0 | 0 | 100 |
| R2 | 40 | 3.5 | 59 | 1 | 0 | 99 |
| R3 | 10 | 2.2 | 89 | 1 | 0 | 99 |

I = according to the invention; R = reference; underlined values: not according to the invention.

### Table 4

Table 4 exemplifies the mechanical properties of both the inventive steel and reference steels. In order to determine the tensile strength, yield strength and total elongation, tensile tests are conducted in accordance of NBN EN ISO 6892-1, method B on an A80 specimens.

The results of the various mechanical tests conducted in accordance to the standards are gathered

TABLE 4

| | | | Total | |
|---|---|---|---|---|
| | Tensile | | Elongation | Yield |
| Trials | Strength(MPa) | TS/YS | (%) | Strength(MPa) |
| I1 | 689 | 1.12 | 16 | 615 |
| I2 | 689 | 1.14 | 18 | 600 |
| I3 | 724 | 1.15 | 15 | 629 |
| I4 | 664 | 1.18 | 17 | 559 |
| R1 | 555 | 1.10 | 25 | 500 |
| R2 | 690 | 1.06 | 14 | 650 |
| R3 | 800 | 1.03 | 12 | 785 |

I = according to the invention; R = reference; underlined values: not according to the invention.

What is claimed is:

1-14. (canceled)

15. A cold rolled and heat treated steel sheet having a composition comprising the following elements, expressed in percentage by weight:
0.05%≤Carbon≤0.12%
1.0%≤Manganese≤2%
0.01%≤Silicon≤0.5%
0.01%≤Aluminum≤0.1%
0.01%≤Niobium≤0.1%
0%≤Phosphorus≤0.09%
0%≤Sulfur≤0.09%
0%≤Nitrogen≤0.09%
and optionally one or more of the following elements
0.1%≤Chromium≤0.5%
0%≤Nickel≤3%
0%≤Titanium≤0.1%
0%≤Calcium≤0.005%
0%≤Copper≤2%
0%≤Molybdenum≤0.5%
0%≤Vanadium≤0.1%
0%≤Boron≤0.003%
0%≤Magnesium≤0.010%
0%≤Zirconium≤0.010%
a remainder of the composition being composed of iron and unavoidable impurities caused by processing,
a microstructure of the steel sheet comprising in area fraction, 50 to 90% Recrystallized ferrite, 10 to 50% non-recrystallized ferrite, 0% to 15% Cementite and 0.5% to 2% Carbides of Niobium, wherein the cumulated amount of Recrystallized ferrite and Non-recrystallized ferrite is at least 85%.

16. The cold rolled and heat treated steel sheet as recited in claim 15 wherein the composition includes 0.01% to 0.4% of Silicon.

17. The cold rolled and heat treated steel sheet as recited in claim 15 wherein the composition includes 0.05% to 0.11% of Carbon.

18. The cold rolled and heat treated steel sheet as recited in claim 15 wherein the composition includes 0.01% to 0.09% of Aluminum.

19. The cold rolled and heat treated steel sheet as recited in claim 15 wherein, the cumulated amounts of Recrystallized ferrite and Non-recrystallized ferrite is at least 90%.

20. The cold rolled and heat treated steel sheet as recited in claim 15 wherein, the amount of Recrystallized ferrite is from 54% to 85%.

21. The cold rolled and heat treated steel sheet as recited in claim 15 wherein the Non-recrystallized ferrite is from 20% to 48%.

22. The cold rolled and heat treated steel sheet as recited in claim 15 wherein the steel sheet has an ultimate tensile strength of 600 MPa or more, and a total elongation of 14% or more and a yield strength to tensile strength ratio equal to or greater than 1.10.

23. The cold rolled and heat treated steel sheet as recited in claim 15 wherein said steel sheet has a yield strength of 550 MPa or more.

24. A method of production of a cold rolled and heat treated steel sheet comprising the following successive steps:
providing a semi-finished product with a steel composition comprising the following elements, expressed in percentage by weight:
0.05%≤Carbon≤0.12%
1.0%≤Manganese≤2%
0.01%≤Silicon≤0.5%
0.01%≤Aluminum≤0.1%
0.01%≤Niobium≤0.1%
0%≤Phosphorus≤0.09%
0%≤Sulfur≤0.09%
0%≤Nitrogen≤0.09%
and optionally one or more of the following elements
0.1%≤Chromium≤0.5%
0%≤Nickel≤3%
0%≤Titanium≤0.1%
0%≤Calcium≤0.005%
0%≤Copper≤2%
0%≤Molybdenum≤0.5%
0%≤Vanadium≤0.1%
0%≤Boron≤0.003%
0%≤Zirconium≤0.010%
a remainder of the composition being composed of iron and unavoidable impurities caused by processing,
reheating the semi-finished product to a temperature from 1000° C. to 1280° C.;
rolling the semi-finished product in the temperature range from Ac3 to Ac3+100° C.,
wherein the hot rolling finishing temperature is above Ac3 to obtain a hot rolled steel;
cooling the hot rolled steel at a cooling rate above 20° C./s to a coiling temperature
which is from 450° C. to 650° C.; and coiling the hot rolled steel;
cooling the hot rolled steel to room temperature;
optionally performing scale removal process on the hot rolled steel sheet;
optionally annealing the hot rolled steel sheet from 400° C. to 750° C.;
optionally performing a scale removal process on the hot rolled steel sheet;
cold rolling the hot rolled steel sheet with a reduction rate from 35 to 90% to obtain a cold rolled steel sheet;
annealing the cold rolled steel sheet in two steps heating wherein:
the first step starts from heating the steel sheet from room temperature to a temperature T1 from 580° C. to 650° C., with a heating rate HR1 of at least 20° C./s,
the second step starts from heating further the steel sheet from T1 to a soaking temperature T2 from 700° C. to 760° C., with a heating rate HR2 of 2° C./s or more, HR2 being lower than HR1, then perform annealing at T2 during 10 to 500 seconds;
then cooling the cold rolled steel sheet from T2 to an holding temperature T3 from 400° C. to 500° C. at an average cooling rate of at least 10° C./s;
then holding the cold rolled steel sheet at T3 for 10 to 500 seconds and bringing the cold rolled steel sheet to a temperature range from 420° C. to 480° C.;
then coating the cold rolled sheet to obtain a cold rolled and heat treated steel sheet.

25. The method as recited in claim 24 wherein the coiling temperature is from 450° C. to 625° C.

26. The method as recited in claim 24 wherein the finishing rolling temperature is more than 850° C.

27. A method for using the steel sheet produced according to the method of claim 24 comprising manufacturing of structural steel.

28. A steel structure comprising a part obtained according to the method of claim 27.

29. A method for using the steel sheet as recited in claim 15 comprising manufacturing of structural steel.

30. A steel structure comprising a part obtained according to the method of claim 29.
